(19) United States
(12) Patent Application Publication
(10) Pub. No.: US 2008/0177526 A1
(43) Pub. Date: Jul. 24, 2008

(54) COMPUTER PROGRAM, COMPUTER APPARATUS AND METHOD FOR SCHEDULING PROCESSES FOR PROJECT PROGRESS

(75) Inventors: Makoto Kano, Yokohama-shi (JP); Mika Koganeyama, Yokohama-shi (JP); Akio Koide, Yokohama-shi (JP); Takao Yoshizawa, Kawasaki-shi (JP)

Correspondence Address: Anne Vachon Dougherty, 3173 Cedar Road, Yorktown Hts., NY, 10598, US

(73) Assignee: International Business Machines Corporation, Armonk, NY (US)

(21) Appl. No.: 12/017,760

(22) Filed: Jan. 22, 2008

(30) Foreign Application Priority Data
Jan. 22, 2007 (JP) 2007-11944

(51) Int. Cl. G06F 9/45

(52) U.S. Cl. 703/22

(57) ABSTRACT

A method and apparatus for arranging a progress schedule of a project includes steps for causing a computer to execute multiple simulations of the project, to select the simulation results indicating that the project would not be complete by the deadline among all the obtained simulation results, to modify the schedule of the selected results by increasing the workload per day for each process so that the project would be completed by the deadline, and to present the increased workload per day as recommended workload per day for each process.

### FIELD OF THE INVENTION

The present invention relates to a computer program, a computer apparatus and a method for arranging a progress schedule of a project, and particularly relates to a computer program, a computer apparatus and a method for arranging a progress schedule of a project in order to avoid a concentration of workload only on limited processes included in the project.

### BACKGROUND OF THE INVENTION

Generally, various types of projects typified by product development are each composed of multiple processes, and the multiple processes are linked with each other through relationships between preceding processes and posterior processes. A relationship between a preceding process and a posterior process means a dependency between processes such as a relationship in which the completion of a preceding process is a condition for starting a next process, or in which the completion of the next process is a condition for starting a posterior process.

In other words, a project is typically composed of a series of processes that are linked to each other from the starting process to the ending process through dependencies between the processes.

The progress of a project is managed, for example, by monitoring whether major processes are each completed within a predetermined period reckoned from the start of the starting process. This major process is called a milestone process in some cases.

In a general project progress management, when a delay from the schedule is detected in the progress of a milestone process, the delay in the project progress is often recovered by increasing the work speed of the milestone process itself, and the work speed of a preceding process which is close to the milestone process, and which the milestone process depends on.

However, such progress management imposes an excessive workload on the milestone process or the immediately preceding process as compared with the normal time. As a result, the work quality of these processes often decreases.

Japanese Patent Application Laid-open Publication No. 2002-99318 discloses a system for reducing the turnaround time from the start to the completion of processing a production lot in the following way. In a case where a person responsible is assigned to each of processes in a production line, the system is capable of clearly figuring out, as needed, the person responsible for each process and the pace of progress of processing a production lot of which the person responsible takes charge. Thereby, the system makes it possible to promptly take a countermeasure depending on the cause of a delay, if it occurs, in the progress of processing the lot, and also makes it easy to motivate each of the persons responsible to increase the progress speed.

Nevertheless, this patent document does not disclose a system for managing the progress in a production line so that the influence of an increase of the processing speed would not concentrate only on limited people in charge of the processes in the production line.

In Newmann, Klaus and Ulrich Steinhardt, GERT Networks and the Time-Oriented Evaluation of Projects, Springer Verlag, New York, 1979, described is a method for estimating the time required for a project to reach a milestone process. In this method, uncertainty factors such as fluctuation of workload in each process and an occurrence of rework of each process are recognized as probabilistic events and are expressed as models. The models thus expressed are processed through Monte Carlo simulations to figure out the expectation value and the variance of a time period required for a project to reach a milestone process in a case where each of processes is executed with standard workload per unit time.

However, this method neither is for adjusting workload per unit time in order to further reduce a time before the milestone process, nor is for dispersing the required time reduction across the entire project in order not to reduce a required time only in limited processes when the required time needs to be reduced.

### SUMMARY OF THE INVENTION

As described above, the conventional techniques are not able to disperse a change in the working schedule throughout all the processes in the entire project when a delay in project progress is detected, even though such dispersion is desirable for the purpose of avoiding a large change in the working schedule only of limited processes.

According to the present invention, provided is a computer program for adjusting a progress schedule of a project. Here, the project includes (i) a plurality of processes having (ii) a certain process related, through information on dependency between processes, to at least any one of (ii)-(1) a preceding process and (ii)-(2) a posterior process included in the plurality of processes. The preceding process is a process, the completion of which is a condition for starting the certain process, and the posterior process is a process that starts on condition that the certain process is completed. The plurality of processes include (iii) a starting process not related to any preceding process and (iv) an ending process not related to any posterior process. In addition, the project has (v) standard workload per day defined for each process and (vi) the workload for each process given as a probability distribution. Furthermore, the project has (vii) a predetermined ideal total time defined as an elapsed time from the start of the starting process to the completion of the ending process.

The computer program provided by the present invention causes a computer to operate the following means: that is, (1) means for simulating the project, further comprising (a) means for computing estimated workload for each process based on the probability distribution, and (b) means for computing an expected total time based on the computed estimated workload for each process and the information on dependency between processes, the expected total time being a time expected to elapse from the start of the starting process to the completion of the ending process; (2) means for obtaining a plurality of simulation results each containing the expected total time and the estimated workload for each process by executing the means for simulating the project a predetermined number of times N; (3) means for selecting, among the plurality of simulation results, a delayed simulation result having the expected total time larger than the ideal total time; (4) means for computing appropriate workload per day for each process included in the selected delayed simulation result, on the basis of the estimated workload for each process and a delay rate that is a ratio of the expected total time to the ideal total time; and (5) means for computing recommended workload per day for each process included in the project, on the basis of the appropriate workload per day for each process included in each of the delayed simulation results.

Here, the means for obtaining a plurality of simulation results may compute the expected total time for each of process paths each lying between one of the starting processes and a corresponding one of the ending processes on the basis of the information on dependency between processes.

In addition, the means for computing appropriate workload per day for each process may compute the appropriate workload per day for each process based on the largest value of the delay rate among all of the process paths and the estimated workload for each process.

Moreover, the means for computing recommended workload per day for each process may further select a predetermined number of delayed simulation results in ascending order of the delay rate, among the selected delayed simulation results, compute a ratio (a rate of increase in workload after the modification) of the appropriate workload per day to the standard workload per day for each process in each of the further selected delayed simulation results, compare the ratios of the further selected delayed simulation results with one another for each process, and then determines, as the recommended workload per day for each process, the appropriate workload per day having the highest ratio for the process.

Further, the predetermined number may be expressed by a formula N*P−K . . . . Formula (1), where P denotes a target probability of obtaining a simulation result indicating that the expected total time is equal to or less than the ideal total time in a case of newly executing the simulation based on the recommended workload per day for each process, and K denotes the number of simulation results each indicating that the expected total time is equal to or less than the ideal total time, among the N times simulation results obtained by the means for simulating a project.

Furthermore, at least one of the processes in the project may have a rework occurrence probability defined, and the means for computing an expected total time may compute the expected total time based on the computed estimated workload for each process, the information on dependency between processes and the rework occurrence probability.

Other features of the present invention will be clarified through the following descriptions of a preferred embodiment for carrying out the invention.

### BRIEF DESCRIPTION OF THE DRAWING

FIG. 1 is a schematic diagram of a hardware configuration for implementing a computer apparatus 100 of the present invention.

FIG. 2 is an example of a diagram of a project model.

FIG. 3 is a data table corresponding to the project model shown in FIG. 2.

FIG. 4 is a diagram of a system configuration of the computer apparatus of the present invention.

FIG. 5 shows simulation results of a project model.

FIG. 6 is a block diagram showing a delayed simulation result.

FIG. 7 is an arrow diagram showing a delayed simulation result.

FIG. 8 is a partially reconfigured arrow diagram.

FIG. 9 shows a procedure of a reconfiguration of an arrow diagram.

FIG. 10 shows another procedure of a reconfiguration of an arrow diagram.

FIG. 11 shows still another procedure of a reconfiguration of an arrow diagram.

FIG. 12 shows an arrow diagram obtained upon completion of a reconfiguration.

FIG. 13 shows sorted delayed simulation results.

FIG. 14 shows a flowchart representing an outline of processing executed by the computer apparatus of the present invention.

FIG. 15 shows a flowchart representing an outline of processing in step 1410 in FIG. 14.

### DETAILED DESCRIPTION OF THE INVENTION

### A Hardware Configuration

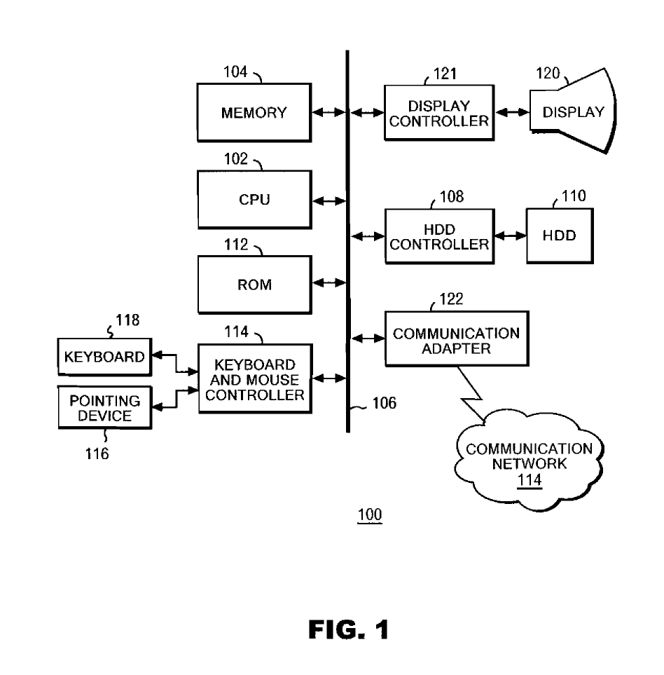

FIG. 1 is a schematic diagram of a hardware configuration for implementing a computer apparatus 100 of the present invention. The computer apparatus 100 includes a central processing unit (CPU) 102 and a memory 104. The CPU 102 and the memory 104 are connected to a hard disk device 110 serving as an auxiliary storage device via a bus 106 and a hard click controller 108.

It is possible to store, in a storage medium such as this hard disk device 110 or a ROM 112, codes of a computer program and various kinds of data for carrying out the present invention by issuing commands to the CPU 102 and the like in cooperation with an operating system.

The codes of the computer program are loaded to the memory 104 and then are executed. The codes of this computer program can be divided into multiple pieces and stored in multiple storage media. Instead, the multiple divided codes can be caused to operate together while a part of the multiple divided codes is stored in a storage medium in another information processing apparatus connected to the computer apparatus 100 through a communication network 114. The technique of allowing divided codes to operate in collaboration with each other with the divided codes dispersed to multiple apparatuses has been implemented as a client server system. Accordingly, when such a system is designed, it is possible to appropriately select which code is to be executed by each apparatus to implement each function. The present invention includes any type of the system.

The computer apparatus 100 further includes user interface hardware. As the user interface hardware, the computer apparatus 100 has a pointing device (a mouse, joystick, touch panel and the like) 116, a keyboard 118 for supporting key inputs, and a display 120 for showing a user a document image to be edited.

The computer apparatus 100 of the present invention can communicate with another computer via a communication adapter 122.

The aforementioned hardware configuration can be implemented with any information processing apparatus such as a personal computer, a work station, office equipment, a home appliance, a mobile phone and in-car equipment. In addition, the aforementioned components are only examples, and all the components are not necessarily indispensable for the present invention.

As an operating system, a preferable one is an operating system, such as Windows XP®, AIX® or Linux®, that supports a graphic user interface multi-window environment as a standard feature, but another type of operating system can be employed. The environment for the present invention is not limited to that based on a specific operating system.

### B Explanation of Terms

Prior to the detail description of a system configuration of the present invention, the definitions of terms are provided. Project: In this description, a project means any activity for obtaining information on a certain target, for generating a new product or new information, or for modifying and improving a target. To be more precise, the project includes activities for designing and manufacturing an industrial product such as an automobile or a semiconductor, preparation for an event such as a conference, policy making and the like. The project can target any of products, information and outcomes including a component of an automobile and an intermediate product of a commercial product. As such, project targets are not necessarily limited to products and information merchandised in markets.

Process: In this description, a process means a set of works, tasks, processing and the like carried out during the implementation of a project for the purpose of obtaining a certain outcome. As is clear from the definition of the project, the process is not limited to a task for producing an industrial product.

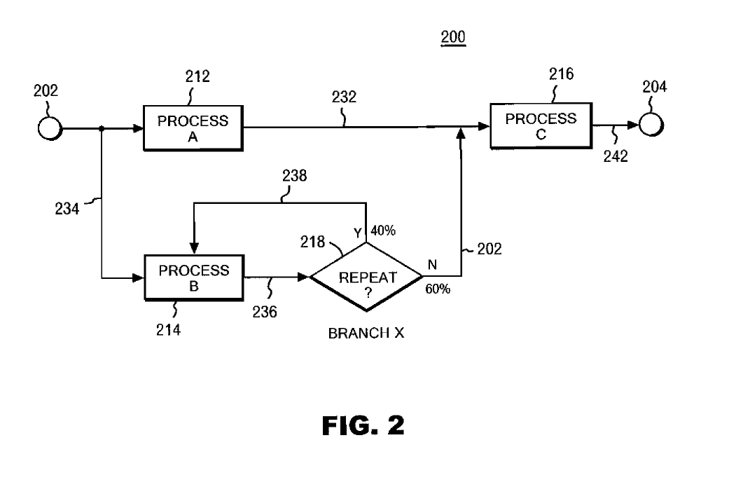

Project model: A project can be modeled by using attributes such as a process ID, a characteristic of a process and information on dependency between processes. FIG. 2 shows an example of a diagram illustrating a project model. Basic elements of the diagram include processes 212, 214 and 216 and edges 232, 234, 236 and 240 each indicating relationships between a pair of processes that are arranged along a time axis indicating the passage of time in the left to right direction in the drawing. A start point 202 and an end point 204 can be arranged in any certain time points on the time axis. The passage of time from the start point 202 to the end point 204 can be defined as the number of days required for a project. For example, when the start point 202 is defined as an elapsed time 0, the end point 204 is a time of completing the project. The end point 204 can be considered as a deadline of the project.

As will be understood by a person skilled in the art, the project model shown in FIG. 2 can be expressed in a data table format and be stored in a storage device so that a computer can use the project model.

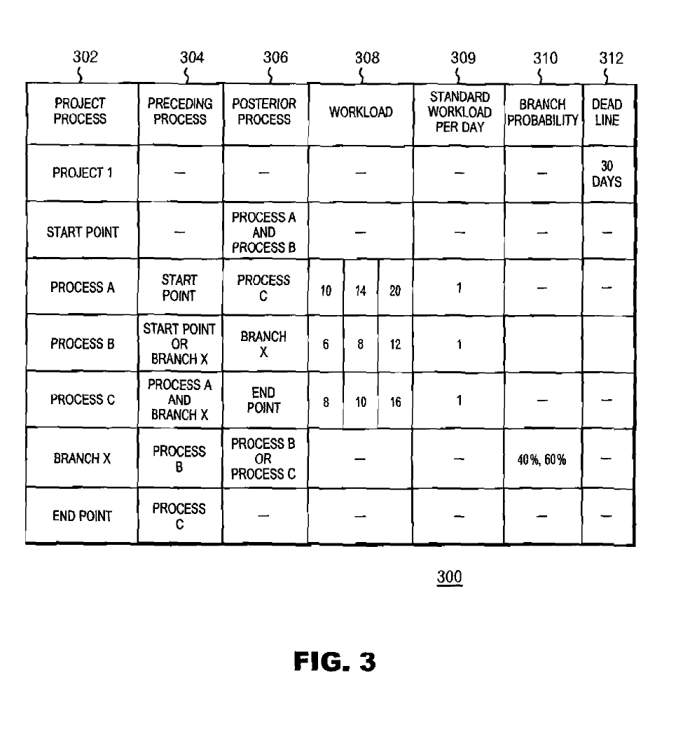

FIG. 3 shows a data table format of the project model shown in FIG. 2. In project process fields 302, information for identifying a project and processes, such as names or ID numbers are filled in.

A deadline 312 is defined for the project. The deadline is a time period which is to elapse from the start point 202 to the end point 204 of the project.

Each process is associated with preceding processes 304 and posterior processes 306. For example, since a process A is one of first processes in a project 200, a preceding process field is filled in with the start point. On the other hand, a process C is allowed to start upon completion of the process A, and thus a posterior process field is filled with the name of the process C. In addition, a process B is also one of the first processes in the project 200, and the start point is written in the preceding process field thereof. Moreover, a branching point X is also written in the preceding process field, because the process B is sometimes carried out again through the branching point X. In the same manner, the information on the preceding processes and the posterior processes is written for other processes in the table.

The explanation for standard workload per day and a branch probability will be provided later.

Information on dependency between processes: As described in the definition of the project model, each process has corresponding preceding processes and posterior processes. These processes are related to each other through relationships in which the completion of the preceding process is a condition for starting the process, and in which the completion of the process is a condition for starting the posterior process. These relationships are written in the preceding process field and the posterior process field in a data table 300 to form the information on dependency between processes. Note that, since any appropriate format of data indicating these relationships can be selected in accordance with an application, it is obvious that the format is not limited to that shown in FIGS. 2 and 3.

Starting process: A starting process is a process not related to any preceding process. The process A 212 and the process B 214 in FIG. 2 are the starting processes.

Ending process: An ending process is a process not related to any posterior process. The process C 216 in FIG. 2 is the ending process.

Workload: Workload means an amount of labor required from the start to the end of a process. Any unit can be selected in accordance with an application. For example, man-month, man-day, man-hour or the like can be employed. The workload of a certain process may be assumed to vary according to a probability distribution.

Standard workload per day: This means workload expected to be normally needed for each process per day. The standard workload per day may be determined by a project manager according to his/her own experience or to an execution result of the process in the past.

The data table 300 shown in FIG. 3 is composed on the assumption that the workload of each process A, B and C varies according to a certain probability distribution. This example employs the assumption that the probability distribution of the workload is a triangular distribution. More precisely, a best case value (BCV), a most likely value (MLV) and a worst case value (WCV) are written in this order from the left-most field in a workload field. In other words, the workload for each process varies within a range of the BCV to the WCV according to the triangular distribution.

As a pattern of distribution and values of BCV, MLV and WCV, it is possible to select any pattern and values suitable for an application.

Moreover, the workload for each process can be simulated by using a combination of a random number generator and a given distribution.

Ideal total time: This is a target value of a time to be required from the start of a starting process to the completion of an ending process of a project. Typically, the ideal total time is based on a time limit or deadline for the completion of a project. As a unit for the ideal total time, day, hour or the like can be selected according to an application.

Estimated workload: Estimated workload for a process means workload obtained by simulating workload for the process on the assumption that the workload for the process varies according to the probability distribution, as described above.

Project simulation: Through project simulation, the workload for each process is estimated according to the aforementioned project model, and also a time to be required from the start of the starting process to the completion of the ending process of the project is estimated by using the information on dependency between processes.

Expected total time: An expected total time is a time estimated from the aforementioned project simulation. When there are multiple paths from the starting process to the ending process, the expected total time may be figured out for each of the paths.

Delayed simulation result: This is a result of the project simulation in which the expected total time is longer than the ideal total time. In general, the simulation results include a certain number of delayed simulation results when the project simulations based on a certain project model are performed multiple times.

Delay rate: In some cases, the aforementioned project model has multiple paths from the start to the end of the project. For example, the model shown in FIG. 2 has two paths between a start point 202 and an end point 204. More precisely, the model has a first path including the processes A and C, and a second path including the processes B and C. Accordingly, the two expected total times for these two paths can be obtained by simulation.

A delay rate for each path is a value obtained by calculating the expected total time/the ideal total time for the path.

Appropriate workload per day: When a path having the delay rate exceeding 100% is found as a result of the simulation, it is preferable to modify the workload per day for each process included in the path in the subsequent simulation in order to prevent the delay in the path. The modified workload per day is referred to as appropriate workload per day. For example, when a path having the delay rate of 113% is found as a result of the simulation, the probability of preventing the delay in the path is expected to increase in a way that the current workload per day for each process included in the path is firstly divided by 1.13 to obtain new workload per day, that is, the appropriate workload per day, and that then the project simulation using the appropriate workload per day is again performed.

Here, note that the appropriate workload per day for each process is obtained for each simulation result.

Recommended workload per day: Recommended workload per day refers to workload per day for each process that is finally presented to a user by the computer apparatus of the present invention. In other words, the computer apparatus of the present invention firstly simulates the project by using the standard workload per day for each process, and then presents, to the user, new workload per day, that is, the recommended workload per day for each process obtained from the simulation. The user can complete the project by the deadline if the project progress is managed according to the recommended workload per day.

As described in the definition of the appropriate workload per day, the appropriate workload per day is obtained for each simulation result. Accordingly, when a simulation result shows a path having a large delay rate, the appropriate workload per day for each process included in the path is increased largely from the standard workload per day. In contrast, when another simulation result shows a path having a small delay rate, the appropriate workload per day for each process included in the path is increased only to some extent from the standard workload per day.

For this reason, the project schedule is not always modified to suit the user's purposes, when the appropriate workload per day based on a certain simulation result is employed as the recommended workload per day without any modification. In a case where an extremely large delay rate is obtained as a result of the simulation, the resultant recommended workload per day is workload largely increased from the standard workload per day.

In other words, the schedule of each process becomes extremely tight. However, in some cases, an extremely-tight schedule of each process is not realistic since such tight schedule is a problem from the viewpoint of quality management.

Specifically, it is preferable that the recommended workload per day be obtained in such a way that the appropriate workload per day resulting from each simulation is appropriately weighted and then reflected. A preferred example of the weighting will be described in detail in a section of an example of the embodiment. In essence, a user decides a target probability of completing the project by the deadline date, and then the schedule is modified (the recommended workload per day for each process is presented) to the extent necessary and sufficient for achieving the target probability. In short, an excessive change in the schedule is prevented.

### C System Configuration

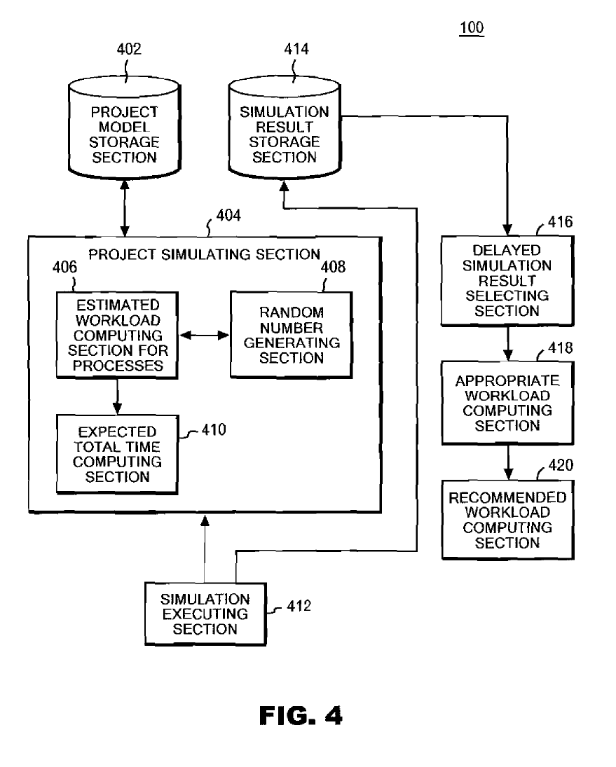

Hereinafter, a system configuration of the computer apparatus of the present invention will be described by referring to FIG. 4. Functional blocks shown in FIG. 4 are logical functional blocks, and FIG. 4 does not necessarily indicate that each of the functional blocks is implemented by a unit of hardware or software. Each of the functional blocks can be implemented by an individually independent unit of hardware, a collaboration of units of hardware, a common hardware or software.

In a preferred embodiment of the present invention, the computer apparatus 100 includes a project model storage section 402, a project simulating section 404, an estimated workload computing section 406 for process, a random number generating section 408, an expected total time computing section 410, a simulation executing section 412, a simulation result storage section 414, a delayed simulation result selecting section 416, an appropriate workload computing section 418 and a recommended workload computing section 420.

The project model storage section 402 stores a modeled expression of the project, for example, data shown in FIG. 3. A project model may be inputted by a user with an appropriate input application through the input devices 118 and 116.

Upon receipt of an instruction from the simulation executing section 412, which will be described later, the project simulating section 404 simulates the project on the basis of the project model stored in the project model storage section 402. More precisely, the estimated workload computing section 406 for process computes the estimated workload for each process based on the probability distribution of a workload 308 of the process included in the project model. Moreover, the estimated workload computing section 406 also computes the estimated workload for each process based on the branching probability 310 that a rework of the process occurs, in some cases.

In order to support the estimated workload computing section 406 when the computing section 406 computes the estimated workload based on the workload 308 given as the probability distribution and the branching probability 310, the random number generating section 408 may be provided to operate in cooperation with the estimated workload computing section 406. The branching probability is defined as the probability of repeatedly executing the process B. For example, the process B is repeated with the probability of 40% in the example shown in FIG. 3.

The expected total time computing section 410 computes a total time to be required from the starting process to the ending process on the basis of the estimated workload of each process computed by the estimated workload computing section 406. The expected total time is computed for each path when there are multiple paths between the start point and the end point (for instance, the points 202 and 204 in FIG. 2) of a project. The expected total time of each path and the estimated workload for each process, which are thus computed, are stored in the simulation result storage section 414 via the simulation executing section 412.

The simulation executing section 412 issues an instruction to the project simulating section 404 to execute the simulation on the project model, and receives the simulation results from the project simulating section 404. As described in detail later, the simulation executing section 412 receives the simulation results as many as the number of executed simulations from the project simulating section 404. The simulation executing section 412 stores each of the simulation results in the simulation result storage section 414.

The delayed simulation result selecting section 416 selects the simulation results each indicating a path having the delay rate exceeding 100% among the simulation results stored in the simulation result storage section 414.

The appropriate workload computing section 418 computes the appropriate workload per day for each process based on each of the selected delayed simulation results.

The recommended workload computing section 420 computes the recommended workload per day for each process in the simulation model on the basis of the appropriate workload per day for each process, which is computed by the appropriate workload computing section 418, corresponding to each of the delayed simulation results. The recommended workload per day thus computed may be displayed on the display 120. Moreover, the recommended workload per day may be transmitted to other application software through the communication network 114, and then be used for the progress management of the project.

### D Example

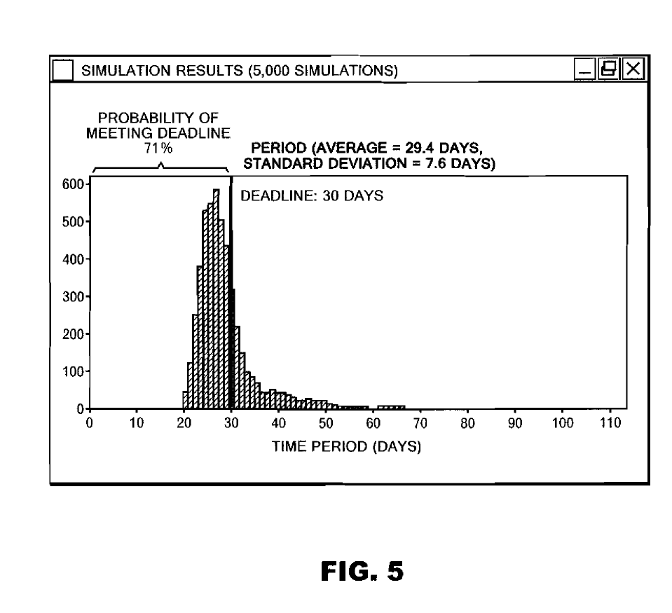

Hereinafter, by referring to FIGS. 5 to 15, descriptions will be provided for a procedure of obtaining the recommended workload per day for each process included in a project by performing the simulations based on the project model with the computer apparatus 100 of the present invention.

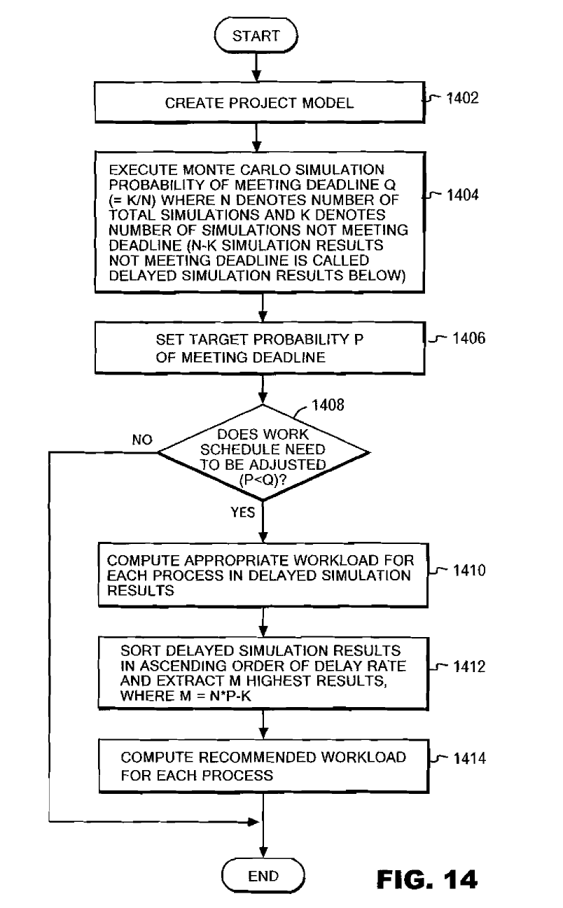

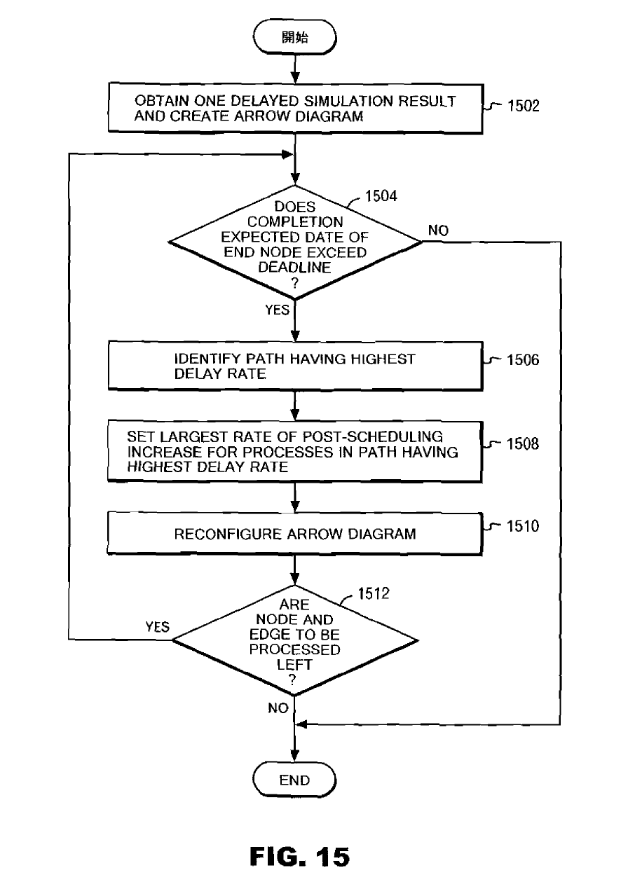

FIG. 14 shows an outline of the following processing, and FIG. 15 shows a detail of step 1410 shown in FIG. 14.

Here, it is not pointed out which component of the computer apparatus 100 of the present invention executes each step in the procedure as long as it is not necessary in particular, but this is obvious to those skilled in the art if they read this section together with the section of “C System Configuration” describing the function of each component.

### D-1 Creating a Project Model (Step 1402)

It is preferable to create a project model based on the assumption that fluctuation in the workload for each process included in the project and an occurrence of rework of the process are probabilistic events. Specifically, on such assumption, a project model as shown in FIG. 2 is created and a data table is created as one form of expression of the model as shown in FIG. 3. 30 days are given as a deadline 312 for the project. The deadline is a time period which is to elapse from the start point 202 to the end point 204 of the project.

D-2 Executing Monte Carlo Simulations (step 1404)

A predetermined number of times, the Monte Carlo simulations of the project based on the simulation model thus created are executed. FIG. 5 shows a frequency distribution of the expected total time in a case where the simulations of the project model shown in FIGS. 2 and 3 are executed 5000 times.

The horizontal axis indicates the expected total time (unit: day) of the project obtained by each simulation.

The vertical axis indicates the number of occurrences of simulation results showing each of the expected total time.

The expected total times of the respective simulation results are distributed around the deadline of 30 days.

Among them, there are 3554 simulation results indicating that the project can be completed by the deadline.

In other words, 71% of the 5000 simulation results meet the deadline.

In the following descriptions, N denotes the number of simulations, K denotes the number of simulation results each having the expected total time that meets the deadline, and Q denotes the probability that the expected total time of the simulation result meets the deadline. In the foregoing example, the values N, K and Q are 5000, 3554 and 71%, respectively.

D-3 Setting the Target Probability p (step 1406)

A user of the computer apparatus of the present invention, typically, a project manager probably desires to obtain simulation results having the expected total time meeting the deadline among the N simulation results with a certain probability or more. The desired probability is here defined as a target probability P.

D-4 Judging the Necessity of Resetting the Standard Workload Per Day (step 1408)

When the target probability P is smaller than the probability Q obtained by the simulation results, there is no need to reset the workload per day for each process in the project model. This is because it can be expected that the project will be completed by the deadline with the probability Q that is greater than the target probability P, by managing each process according to the current standard workload per day. In contrast, in a case where the project is executed by managing each process according to the current standard workload per day when Q<P, the project will be completed by the deadline not with the target probability P, but with a probability lower than the target probability P, as is clear from the aforementioned simulation results. For this reason, the workload per day for each process is reset (revised) as described below.

### D-5 Computing the Appropriate Workload Per Day for Each Process in Each Delayed Simulation Result (Step 1410)

An estimation for each of the delayed simulation results is performed as to how much increase of the workload per day for each process from the currently-given standard workload per day would have prevented the obtaining of the delayed simulation result.

In a case of the simulation result indicating that the expected total time largely exceeds the deadline, it is understandable that the appropriate workload per day for each process is made much smaller than the standard workload per day.

### D-5-1 Creating Arrow Diagrams of Delayed Simulation Results (Step 1502)

In order to facilitate the understanding, a delayed simulation result is expressed in an arrow diagram form, and each step of the processing is described as an operation on the arrow diagram, hereinbelow.

It is easily understood to those skilled in the art that an arrow diagram can be written in a data format which can be stored in the storage devices 104 and 110 as is the case with the data table in FIG. 3, and that the functional blocks shown in FIG. 4 are able to perform a series of operations on the arrow diagram in collaboration with each other.

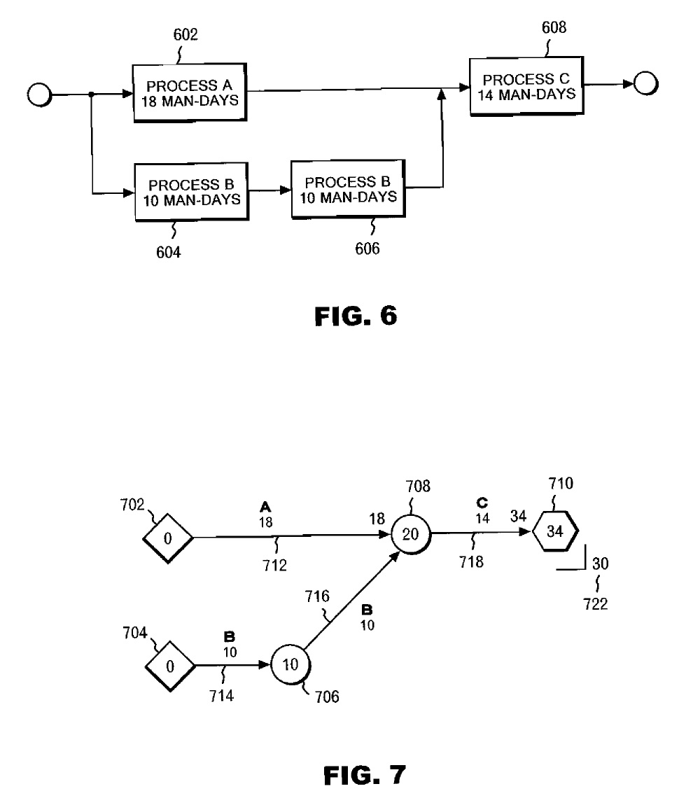

The delayed simulation result can be written in a block diagram form shown in FIG. 6, firstly. The estimated workload for a process obtained as a result of the simulation is written in each of blocks 602, 604, 606 and 608. The reason why two blocks are written for the process B is that the project is simulated on the basis of a model in which the process B is to be repeatedly executed with a certain probability, and that the process B is assumed to be repeatedly executed twice in the delayed simulation result.

FIG. 7 is an arrow diagram of the delayed simulation result.

Each of nodes expressed as squares 702 and 704, circles 706 and 708, a hexagon 710 and the like indicates a start event or a completion event of a process.

Lines 712, 714, 716 and 718 connecting the nodes each indicate a process.

The nodes 702 and 704 each of which indicates the start of a process not related to any preceding process are called start nodes. In addition, the node 710 indicating the completion of the project is called an end node.

A numeric value shown at the right lower side of the end node indicates the deadline.

Note that the standard workload per day for each process is assumed to be 1. More precisely, processes A, B and C require 18, 10 and 14 days, respectively, from the start to completion.

### D-5-2 A Completion Expected Date of an End Node (Step 1504)

A completion expected date of the end node is the maximum value among the expected total times for all the paths described in the section of the explanation of terms.

For example, in an arrow diagram shown in FIG. 7, the expected total time of the path 1 reaching the end node through processes A and C is 18+14=32 days, and that of the path 2 reaching the end node through the process C after executing the process B twice is 34 days. Accordingly, the completion expected date of the end node is 34 days. Since this number of days is larger than 30 days that is the deadline, the appropriate workload per day is obtained by modifying the workload per day for each process in the following manner.

When multiple end nodes exist, the completion expected dates for all the end nodes are computed.

### D-5-3 Identifying the Path Having the Highest Delay Rate (Step 1506)

When there is one or more end nodes each having the completion expected date exceeding the deadline (hereinafter, simply referred to as a “delayed end node”), the path having the highest delay rate defined by the following formula (1) is identified among the paths from one or more start nodes to the one or more delayed end nodes.

Delay rate=Σ(Estimated workloads for All Processes)/(Deadline of Path−Start Date of Path) Formula (1),

where Σ indicates summing up a total of estimated workloads of all the processes included in the path.

The path having the highest delay rate is identified through the following processing, for example, of:

(1) selecting a pair of one delayed end node and one start node connected to the delayed end node, and then forming a sub-arrow diagram composed of the path from the start node to the delayed end node;
(2) computing, in the sub-arrow diagram, the earliest start date of each process starting from the start node, and the latest start date of each process starting from the delayed end node in the reverse order;
(3) determining the path composed of processes each having the same earliest start date and the latest start date, as the path having the highest delay rate between the start node to the delayed end node; and
(4) identifying the path having the highest delay rate by executing the processing (1) to (3) for all the pairs of nodes.

In the example shown in FIG. 7, the delay rate of the path 1 is (18+14)/(30−0)=106%, while the delay rate of the path 2 is (10+10+14)/(30−0)=113%. Accordingly, the path 2 having the highest delay rate of 113% is identified as the path having the highest delay rate.

### D-5-4 Computing the Appropriate Workload Per Day for Each Process Included in the Path Having the Highest Delay Rate (Step 1508)

The appropriate workload per day for each process included in the selected path having the highest delay rate is computed on the basis of the delay rate. At this time, the influence of the path having the highest delay rate on other paths or the influence of the other paths on the path having the highest delay rate is ignored.

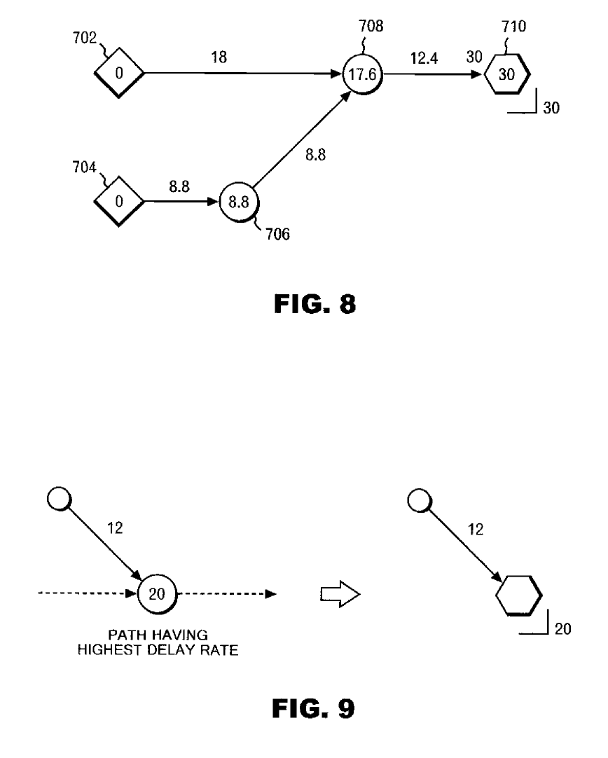

For example, since the delay rate of the path 2 is 113%, the appropriate workload per day for each process is 1.13/1=1.13 as shown in FIG. 8. Moreover, the time periods required for the respective processes are 10/1.13=8.8 days, 10/1.13=8.8 days, 14/1.13=12.4 days, and the total of these time periods is 30 days that is equal to the deadline. By repeating such processing for all the paths, the appropriate workload per day for each process is eventually modified so that the project can be completed by the deadline when being actually implemented.

### D-5-5 The Reconfiguration of the Arrow Diagram (Step 1510)

The edges in the path having the highest delay rate, which is selected in D-5-3, are excluded from the arrow diagram. Nodes losing both input and output edges due to this excluding processing are excluded together with the edges.

The processing is terminated when all the nodes and edges are excluded.

If there is a node in the path having the highest delay rate which has input and/or output edges connected to a node not included in the path having the highest delay rate, any one of the following processing (i) to (iii) is carried out.

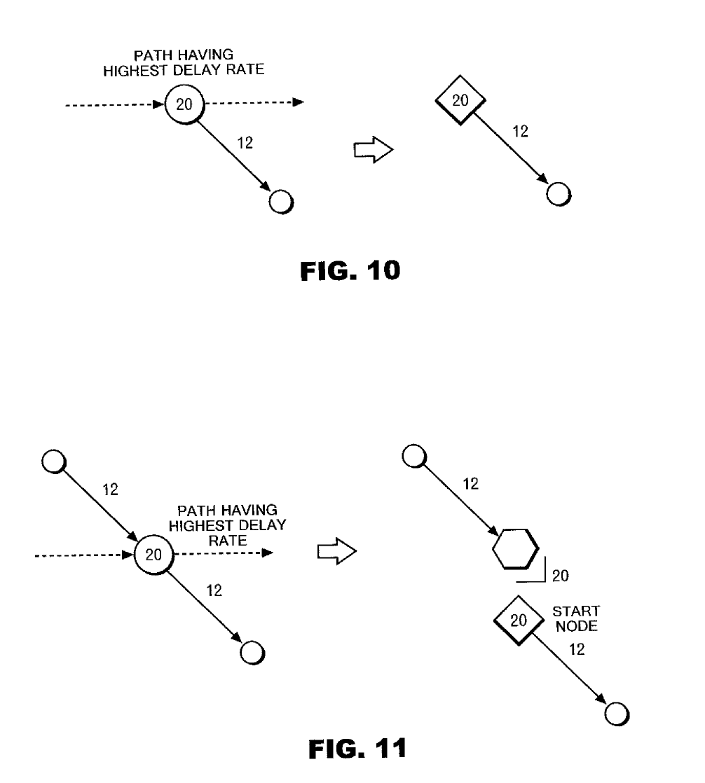

(i) When a certain node in the path having the highest delay rate has an output edge connected to a node not included in the path having the highest delay rate, the certain node is used as the start node, and the start date is set to the earliest start date of the certain node based on the assumption that the project is implemented according to the appropriate workload per day for each process computed in D-5-4 (FIG. 10).
(ii) When a certain node in the path having the highest delay rate has an input edge connected to a node not included in the path having the highest delay rate, the certain node is used as the end node, and the deadline is set to the earliest start date of the certain node based on the assumption that the project is implemented according to the appropriate workload per day for each process computed in D-5-4 (FIG. 9).
(iii) When a certain node in the path having the highest delay rate has both input and output edges connected to nodes not included in the path having the highest delay rate, the certain node is divided into two nodes which are to be used as the start node and the end node, and both the start date of the start node and the deadline of the end node are set to the earliest start date of the certain node based on the assumption that the project is executed according to the appropriate workload per day for each process computed in D-5-4 (FIG. 11).

### D-5-6 The Processing Moves Back to D-5-2 if Any Nodes and Edges to be Processed Remain, or is Otherwise Terminated (Step 1512).

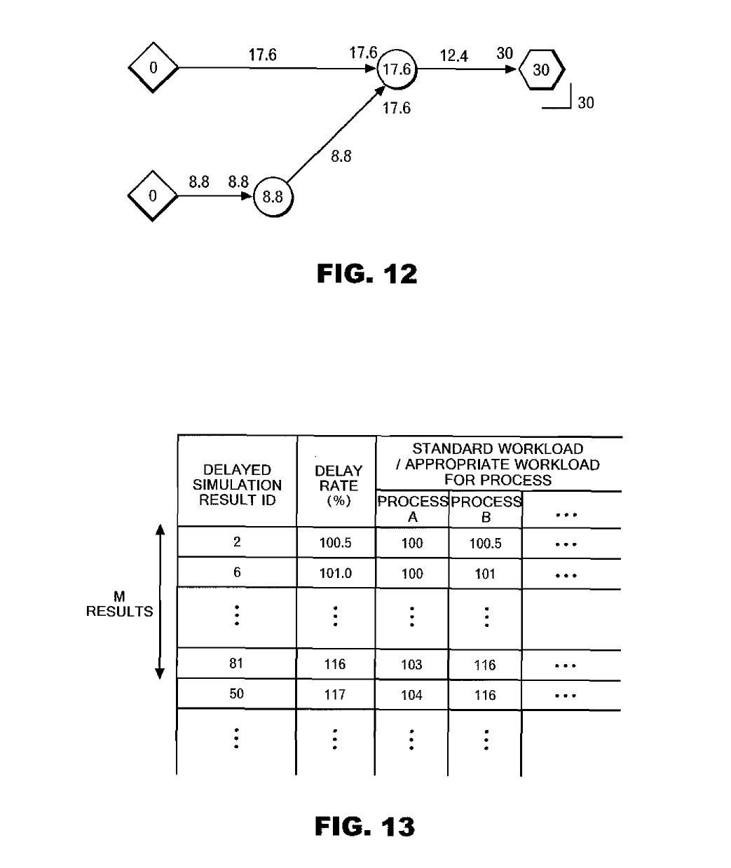

FIG. 12 shows the arrow diagram reconfigured through the above processing.

The arrow diagram of the path 2 having the highest delay rate is reconfigured, and then the arrow diagram of a part of the path 1 is also reconfigured in accordance with the result of the preceding reconfiguration. Thus, the appropriate workload per day for each process in the entire arrow diagram is computed.

### D-6 Sorting the Delayed Simulation Results in Ascending Order of the Delay Rate and Extracting the Highest M Delayed Simulation Results (Step 1412)

The highest delay rate of the delayed simulation result is figured out in the procedure described in D-5-3.

The delay rate of the delayed simulation result shown in the arrow diagram in FIG. 12 is 113%.

Next, the delayed simulation results are sorted in ascending order of the delay rate, and then the highest M delayed simulation results are extracted, where

M=N*P−K Formula (2).

If there are two or more delayed simulation results having the same position in the order of the delay rate, the delayed simulation results are sorted in ascending order of the second highest delay rate of the path included in the delayed simulation results.

If the schedules of paths in the M delayed simulation results are successfully modified so that the project can be completed by the deadline, the probability Q′ of completing the project by the deadline can be made equal to the target probability P by combining the modified schedules and the schedules of the k instances each indicating that the project is completed by the deadline from the beginning.

Q′=(K+M)/N=P Formula (3)

In this way, the appropriate workload per day for each process included in the paths in the highest M simulation results is obtained so that the project can be completed by the deadline. As a result, the appropriate workload per day for each process is prevented from being largely decreased from the standard workload per day that is given in the beginning.

In other words, the minimum necessary number of delayed simulation results for obtaining the target probability P are selected in ascending order of the delay rate, that is, the delayed simulation results (M results) having M lowest delay rates are selected. Then, the appropriate workload per day for each process is figured out according to a corresponding delay rate in each of the delayed simulation results.

### D-7 Computing the Recommended Workload Per Day for Each Process Included in the Project Model (Step 1414)

As shown in FIG. 13, the delayed simulation results are sorted in ascending order of the delay rate, and then the M highest results are selected. It is preferable that the recommended workload per day for each process be determined based on the largest value of the appropriate workload per day/the standard workload per day among the M delayed simulation results. In other words, it is preferable to select, as the recommended workload per day for each process, the appropriate workload per day that is largely increased from the standard workload per day (requires a high reduction rate of a required time).

As described above, according to the present invention, the workload per day for each process in a project can be re-estimated so that the project can be completed by the deadline. In addition, it is possible to avoid a situation in which only the limited processes are subjected to a large increase of the workload per day after the re-estimation. Moreover, this prevents in advance workload, a so-called burden, from being concentrated only on limited processes, and thereby also prevents a deterioration of the performance quality in the project after the schedule of the project is changed.

1. A computer program component for arranging a progress schedule of a project including a plurality of processes including at least one process having a dependency relationship, including a starting condition and a completion condition, with at least one preceding process included in the plurality of processes, the completion of the preceding process being a condition for starting the at least one process, and at least one posterior process, the posterior process starting on condition that the at least one process is completed, the plurality of processes including a starting process not related to any preceding process and an ending process not related to any posterior process, the project having a standard workload per unit time defined for each process given as a probability distribution, and the project having a predetermined ideal total time defined as an elapsed time from the start of the starting process to the completion of the ending process, the computer program causing a computer to operate as:
(1) means for simulating the project, further comprising
a. means for computing estimated workload for each process based on the probability distribution, and
b. means for computing an expected total time based on the computed estimated workload for each process and information on dependency between processes, the expected total time being a time expected to elapse from the start of the starting process to the completion of the ending process;
(2) means for obtaining a plurality of simulation results each containing the expected total time and the estimated workload for each process by executing the means for simulating the project a predetermined number of times N;
(3) means for selecting, from the plurality of simulation results, a delayed simulation result having the expected total time larger than the ideal total time;
(4) means for computing appropriate workload per unit time for each process included in the selected delayed simulation result, on the basis of the estimated workload for each process and a delay rate that is a ratio of the expected total time to the ideal total time; and
(5) means for computing recommended workload per unit time for each process included in the project, on the basis of the appropriate workload per unit time for each process included in each of the delayed simulation results.

2. The computer component according to claim 1, wherein the means for obtaining a plurality of simulation results computes the expected total time for each of process paths lying between a starting process and a corresponding ending process on the basis of the information on dependency between processes.

3. The computer component according to claim 2, wherein the means for computing appropriate workload per unit time for each process computes the appropriate workload per unit time for each process based on the largest value of the delay rate among all of the process paths and the estimated workload for each process.

4. The computer component according to claim 1, wherein the means for computing recommended workload per unit time for each process performs steps of:
selecting a predetermined number of delayed simulation results in ascending order of the delay rate among the selected delayed simulation results,
computing a ratio of the appropriate workload per unit time to the standard workload per unit time for each process in each of the further selected delayed simulation results,
comparing the ratios of the further selected delayed simulation results with one another for each process, and
determining, as the recommended workload per unit time for each process, the appropriate workload per unit time having the highest ratio for the process.

5. The computer component according to claim 4, wherein
the predetermined number is expressed by the following formula (1),
N*P−K Formula (1),
where P denotes a target probability of obtaining a simulation result indicating that the expected total time is equal to or less than the ideal total time in a case of newly executing the simulation based on the recommended workload per unit time for each process, and K denotes the number of simulation results each indicating that the expected total time is equal to or less than the ideal total time, among the N times simulation results obtained by the means for simulating a project.

6. The computer component according to claim 1, wherein
at least one of the processes in the project has a rework occurrence probability defined, and
the means for computing an expected total time computes the expected total time based on the computed estimated workload for each process, the information on dependency between processes and the rework occurrence probability.

7. The computer component according to claim 1, wherein the method further comprises executing said project in accordance with the recommended workload per unit time for each process included in the project.

8. A method for causing a computer including a processor and a storage device to arrange a progress schedule of a project including a plurality of processes including at least one process having a dependency relationship, including a starting condition and a completion condition, with at least one preceding process included in the plurality of processes, the completion of the preceding process being a condition for starting the at least one process, and at least one posterior process, the posterior process starting on condition that the at least one process is completed, the plurality of processes including a starting process not related to any preceding process and an ending process not related to any posterior process, the project having a standard workload per unit time defined for each process given as a probability distribution, and the project having a predetermined ideal total time defined as an elapsed time from the start of the starting process to the completion of the ending process, the method comprising the steps of:
(1) simulating the project by the processor, further including the steps of:
a. computing estimated workload for each process based on the probability distribution, and
b. computing an expected total time based on the computed estimated workload for each process and information on dependency between processes, the expected total time being a time expected to elapse from the start of the starting process to the completion of the ending process;
(2) obtaining a plurality of simulation results each containing the expected total time and the estimated workload for each process by executing the step for simulating the project a predetermined number of times N, and to store the obtained simulation results in the storage device;
(3) selecting, among the plurality of simulation results, a delayed simulation result having the expected total time larger than the ideal total time;
(4) computing appropriate workload per unit time for each process included in the selected delayed simulation result, on the basis of the estimated workload for each process and a delay rate that is a ratio of the expected total time to the ideal total time; and
(5) computing recommended workload per unit time for each process included in the project, on the basis of the appropriate workload per unit time for each process included in each of the delayed simulation results, and to store the recommended workloads in the storage device.

9. The method according to claim 8, wherein the obtaining a plurality of simulation results computes the expected total time for each of process paths lying between a starting process and a corresponding ending process on the basis of the information on dependency between processes.

10. The method according to claim 9, wherein the computing appropriate workload per unit time for each process computes the appropriate workload per unit time for each process based on the largest value of the delay rate among all of the process paths and the estimated workload for each process.

11. The method according to claim 8, wherein the computing recommended workload per unit time for each process comprises the steps of:
selecting a predetermined number of delayed simulation results in ascending order of the delay rate among the selected delayed simulation results,
computing a ratio of the appropriate workload per unit time to the standard workload per unit time for each process in each of the further selected delayed simulation results,
comparing the ratios of the further selected delayed simulation results with one another for each process, and
determining, as the recommended workload per unit time for each process, the appropriate workload per unit time having the highest ratio for the process.

12. The method according to claim 11, wherein
the predetermined number is expressed by the following formula (1),
N*P−K Formula (1),
where P denotes a target probability of obtaining a simulation result indicating that the expected total time is equal to or less than the ideal total time in a case of newly executing the simulation based on the recommended workload per unit time for each process, and K denotes the number of simulation results each indicating that the expected total time is equal to or less than the ideal total time, among the N times simulation results obtained by the means for simulating a project.

13. The method according to claim 8, wherein
at least one of the processes in the project has a rework occurrence probability defined, and
said computing an expected total time computes the expected total time based on the computed estimated workload for each process, the information on dependency between processes and the rework occurrence probability.

14. A computer apparatus for arranging a progress schedule of a project including a plurality of processes including at least one process having a dependency relationship, including a starting condition and a completion condition, with at least one preceding process included in the plurality of processes, the completion of the preceding process being a condition for starting the at least one process, and at least one posterior process, the posterior process starting on condition that the at least one process is completed, the plurality of processes including a starting process not related to any preceding process and an ending process not related to any posterior process, the project having a standard workload per unit time defined for each process given as a probability distribution, and the project having a predetermined ideal total time defined as an elapsed time from the start of the starting process to the completion of the ending process, the computer apparatus comprising:
(1) means for simulating the project, further comprising
a. means for computing estimated workload for each process based on the probability distribution, and
b. means for computing an expected total time based on the computed estimated workload for each process and the information on dependency between processes, the expected total time being a time expected to elapse from the start of the starting process to the completion of the ending process;
(2) means for obtaining a plurality of simulation results each containing the expected total time and the estimated workload for each process by executing the means for simulating the project a predetermined number of times N;
(3) means for selecting, among the plurality of simulation results, a delayed simulation result having the expected total time larger than the ideal total time;
(4) means for computing appropriate workload per unit time for each process included in the selected delayed simulation result, on the basis of the estimated workload for each process and a delay rate that is a ratio of the expected total time to the ideal total time; and
(5) means for computing recommended workload per unit time for each process included in the project, on the basis of the appropriate workload per unit time for each process included in each of the delayed simulation results.
